(19) United States
(12) Patent Application Publication
(10) Pub. No.: US 2022/0194768 A1
(43) Pub. Date: Jun. 23, 2022

(54) CARRIAGE ASSEMBLY

(71) Applicant: J.C. Bamford Excavators Limited, Uttoxeter (GB)

(72) Inventors: Ross Taylor, Uttoxeter (GB); Yogesh Khedkar, Uttoxeter (GB); Rahul Kumbhar, Uttoxeter (GB); Matthew Coope, Uttoxeter (GB); Darryl Cottingham, Uttoxeter (GB)

(73) Assignee: J.C. Bamford Excavators Limited, Uttoxeter (GB)

(21) Appl. No.: 17/555,447

(22) Filed: Dec. 18, 2021

(30) Foreign Application Priority Data
Dec. 18, 2020 (GB) 2020159.6

(51) Int. Cl. B66F 9/18; B66F 9/065

(52) U.S. Cl. CPC B66F 9/18; B66F 17/003; B66F 9/0655

(57) ABSTRACT

A carriage assembly for a working machine, the assembly having a first coupling body pivotally mountable to a working arm to rotate about a first axis, a second coupling body pivotally mounted to the first coupling body to rotate about a second axis, and carriage for a working implement pivotally mounted to the second coupling body to rotate about a third axis.

### FIELD

The present teachings relate to a carriage assembly for a working machine, and to a working machine.

### BACKGROUND

Off-highway vehicles or working machines are for example those used in construction industries configured to transport loads over a surface (e.g. backhoe loaders, slew excavators telescopic handlers, forklifts, skid-steer loaders. One such working machine is a telescopic handler, often referred to as telehandlers or rotating telehandlers, are that are typically used to lift, move and place material or cargo.

The working machine includes a working arm having a working implement, such as forks, a bucket etc., attached at the end of the arm, where the arm can be raised and lowered to move an object (e.g. a loaded pallet). The arm may also be telescopic so that it can extend and retract to move the object. A conventional telehandler might include a pair of spaced apart forks mounted onto the arm via a carriage so as to carry and move an object, and the carriage is maneuvered by an operator of the working machine to pick up, transport and deposit the object. Known machines incorporate carriages that are unable to provide sufficient maneuverability of the working implement, which can hamper operation by an operator.

The present teachings seek to overcome or at least mitigate one or more problems associated with the prior art.

### SUMMARY

A first aspect of the teachings provides a carriage assembly for mounting to a working arm of a working machine, the carriage assembly comprising: a first coupling body comprising an arm mounting arrangement for pivotally mounting the first coupling body to an arm of a working machine so as to be pivotable relative to the arm about a first axis; a second coupling body pivotally mounted to the first coupling body so as to be pivotable relative to first coupling body about a second axis that is substantially perpendicular to the first axis; and a carriage comprising an implement mount for mounting a working implement thereon, wherein the carriage is pivotally mounted to the second coupling body so as to be pivotable relative to the second coupling body about a third axis that is substantially perpendicular to the first axis and the second axis.

This arrangement advantageously enables the forks to be maneuvered about three planes. This arrangement enables a working machine including forks to be much more versatile when handling materials/cargo.

The first axis may be a lateral axis, and/or wherein the second axis may be a substantially upright axis, and/or wherein the third axis may be a fore-aft axis.

This arrangement of the pivoting axes between the arm and first coupling body, between the first and second coupling bodies, and between the carriage and second coupling body has been found to enable a more compact carriage assembly to be constructed. This compact carriage assembly works to bring the center of gravity of the assembly closer to the end of the end of the arm of the working machine, which helps to increase the stability of the carriage assembly.

The assembly may comprise a pair of forks mounted to the carriage, the forks projecting from the carriage in a direction that is substantially parallel to the third axis.

The first coupling body may comprise a base member, a bridge member, and first and second side walls extending therebetween. The arm mounting arrangement may comprise opposing first and second tilt pin holes in the first and second side walls, respectively, configured to receive a tilt pin therethrough for mounting the first coupling body to a working arm of a working machine.

The tilt pin may extend along the first axis. The first axis may be defined by the elongate axis of the tilt pin.

The first axis may extend in a direction between the first and second tilt pin holes. The first axis may be defined by the relative positions of the first and second tilt pin holes.

The first coupling body may comprise a tilt actuator mount for mounting an actuator connectable to an arm of a working machine for tilting the first coupling body relative to the arm about the first axis, in use. The tilt actuator mount may be provided on the base member.

This positioning of the tilt actuator mount has been found to provide increased strength.

The carriage assembly may comprise a first swivel actuator pivotally connected between the first coupling body and the second coupling body to pivot the second coupling body about the second axis.

The first swivel actuator may be connected between the first side wall of the first coupling body and a first lateral side of the second coupling body.

The carriage assembly may comprise a second swivel actuator pivotally connected between the first coupling body and the second coupling body to pivot the second coupling body about the second axis.

The second swivel actuator may be connected between the second side wall of the first coupling body and a second lateral side of the second coupling body.

Providing the swivel actuators on the opposing sides of the assembly has been found enable a more compact assembly, whilst improving the stability of the pivoting of the second coupling body relative to the first coupling body.

The first and second side walls may each comprise a wing portion extending rearwardly from the first axis in a direction away from the second coupling body.

The wing portions may extend from the tilt pin holes in a direction away from the second coupling body.

This provision of rearwardly extending wings (i.e. extending in a direction away from the carriage towards the machine) works to bring the center of gravity of the assembly closer to the end of the end of the arm of the working machine. This, in turn, helps to increase the stability of the carriage assembly.

The first swivel actuator and/or second swivel actuator may connect to the first coupling body rearward of the first axis.

The first swivel actuator and/or second swivel actuator may connect to a respective wing portion, e.g. a distal end of the respective wing portion.

Attaching the actuators rearward of the first axis, i.e. proximate a distal end of a rear extension, enables the swivel actuators to be moved rearwardly (i.e. closer to the arm of the working machine), which enables the center of gravity of the assembly to be closer to the end of the machine arm. This positioning of the swivel actuators also work to provide a more compact carriage assembly.

The first coupling body may comprise a swivel mounting arrangement in the form of opposing first and second swivel pin holes in the base member and bridge member, respectively, configured to receive a swivel pin therethrough for pivotally mounting the second coupling body to the first coupling body.

The first and second swivel pin holes may be spaced apart by a distance greater, e.g. 1.25 or 1.5 times greater, than a spacing between the first and second tilt pin holes.

Providing a greater spacing between the swivel pin holes increases the height of the first coupling body, which has been found to reduce the stress on the components of the assembly.

The second coupling body may comprise a lower cross member, an upper cross member, and a substantially central swivel shaft member extending therebetween. The swivel shaft member may comprise an elongate bore configured to receive a swivel pin therethrough for pivotally mounting the second coupling body to the first coupling body.

The second coupling body may comprise a first and/or second swivel actuator mounts on first and/or second lateral sides of the upper cross member.

The swivel pin extends along the second axis. The elongate bore may define the second axis.

Positioning the swivel pin bore in this location has been found to provide a more compact assembly, thus improving the packing of the assembly.

Positioning of the swivel actuator mounts at these locations has been found to provide increased strength.

The second coupling body may comprise a pivot pin hole configured to receive a pivot pin therethrough for pivotally mounting the carriage to the second coupling body.

The pivot pin hole may define the third axis.

The pivot pin hole may be positioned between, e.g. interposed between, first and second swivel actuator mounts provided on first and second lateral sides of the second coupling body.

Positioning the pivot pin at this location on the second coupling body has been found to provide increased strength.

The pivot pin hole may be aligned vertically with first and second swivel actuator mounts provided on first and second lateral sides of the second coupling body.

Positioning the pivot pin in line between the swivel actuator mounts helps to avoid generating any eccentric forces.

The pivot pin hole may be positioned at a point of intersection between the upper cross member and the swivel shaft member.

Positioning the pivot pin at this location on the second coupling body has been found to provide increased strength.

The pivot pin hole and the elongate bore may be substantially perpendicular and may intersect.

The swivel pin may comprise an aperture configured to receive the pivot pin therethrough.

The pivot pin may comprise a stepped region such that a reduced diameter portion of the pivot pin extends through the aperture.

This arrangement reduces the size of the aperture required, and so reduces the thickness of swivel pin required. This improves packaging of the assembly.

The stepped region may form a stop configured to abut against a perimeter of the pivot pin hole.

The pivot pin and the aperture in the swivel pin may comprise complementary threaded surfaces so as to secure the pivot pin to the swivel pin.

The pivot pin may comprise a stop at a first or forward end for abutting against the carriage and comprises a releasable fastening at a second or rearward end for securing the pivot pin to the swivel pin and/or second coupling body.

The pivot pin may comprise an external threaded portion at the second end and the assembly may comprise a threaded fastener configured to engage the threaded second end to secure the pivot pin to the second coupling body.

The second coupling body may comprise a recess on a surface facing the first coupling body. A portion of the first coupling body may extend into the recess.

The recess may be formed on the lower cross member.

This arrangement provides a more compact assembly, thus improving the packaging of the assembly.

The bore may terminate at an upper wall of the recess and the first coupling body extends into the recess such that a swivel pin hole of the first coupling body aligns with the bore.

This arrangement provides a more compact assembly, thus improving the packaging of the assembly.

The recess may define an upper wall that is received in a corresponding lateral groove on the first coupling body.

This arrangement provides a more compact assembly, thus improving the packaging of the assembly.

The upper wall of the recess may be seated on a part of the first coupling body.

This has been found to improve load transfer through the carriage assembly.

The upper wall of the recess may be seated on a lower wall of the lateral groove.

This has been found to improve load transfer through the carriage assembly.

The recess and the first coupling body interengage to form a stop to limit a pivoting angle of the second coupling body relative to the first coupling body.

The upper wall and lateral groove interengage to form a stop to limit the pivoting angle of the second coupling body relative to the first coupling body.

The carriage assembly may comprise a pivot actuator pivotally connected between the second coupling body and the carriage to pivot the carriage relative to the second coupling body about the third axis.

The pivot actuator may be positioned above the third axis.

The second coupling body may comprise a bracket arm extending from the upper cross member in a direction at least partially away from the lower cross member, and wherein the pivot actuator may be pivotally mounted proximate a distal end of the bracket arm.

Positioning the pivot actuator above the third axis (i.e. on an opposite side of the axis to the ground) has been found to protect the actuator from impacts and/or dirt from below.

The pivot actuator may be positioned above an upper extend of the first coupling body.

The pivot actuator may be positioned above the upper member of the carriage.

The bracket arm may act as a mechanical stop to limit the maximum pivoting angle of the carriage relative to the second coupling body.

The carriage may comprise a lower member, an upper member, and two side members extending therebetween, and wherein the carriage may comprise a pair of spaced apart support members and a pivot plate including a pivot hole mounted to the pair of support members.

This has been found to improve the strength of the carriage assembly.

The implement mount may comprise a fork mounting shaft extending between the two side members.

The fork mounting shaft is mounted to the support members.

The carriage lower cross member may be substantially flush with, e.g. abuts against, the second coupling body.

The carriage lower cross member may abut against the lower cross member of the second coupling body.

This has been found to improve load transfer through the assembly, by reduce the moment of force exerted on the pivot pin.

The first coupling body may be integrally formed, e.g. integrally cast, as a unitary component.

The second coupling body may be integrally formed, e.g. integrally cast, as a unitary component.

A second aspect of the teachings provides a working machine comprising: a body; a ground engaging propulsion arrangement supporting the body; a working arm pivotally connected to the body; and a carriage assembly according to the first aspect mounted to a distal end of the working arm.

The working arm may have a first end pivotally connected the body and a second end having the carriage assembly mounted thereto.

The working arm may be telescopic.

The body may include an undercarriage or chassis including the ground engaging propulsion arrangement, and a superstructure including the cab and working arm.

The superstructure may be rotatable (e.g. about a substantially vertical axis) relative to the undercarriage/chassis and/or the ground engaging propulsion structure.

### BRIEF DESCRIPTION OF THE DRAWINGS

Embodiments will now be described with reference to the accompanying drawings, in which:

FIG. 1 is a side view of a working machine according to an embodiment;

FIG. 2 is an enlarged side view of the arm and carriage assembly of FIG. 1;

FIG. 3 is a cross-sectional side view of FIG. 2;

FIG. 4 is an exploded isometric view of a carriage assembly according to an embodiment;

FIG. 5 is an isometric view of a first coupling body of the carriage assembly of FIG. 4;

FIG. 6 is an isometric view of a second coupling body of the carriage assembly of FIG. 4;

FIG. 7 is a front view of the carriage assembly of FIG. 4 in an assembled state; and

FIG. 8 is a partial rear isometric view of the carriage assembly of FIG. 4 in an assembled state.

### DETAILED DESCRIPTION OF EMBODIMENT(S)

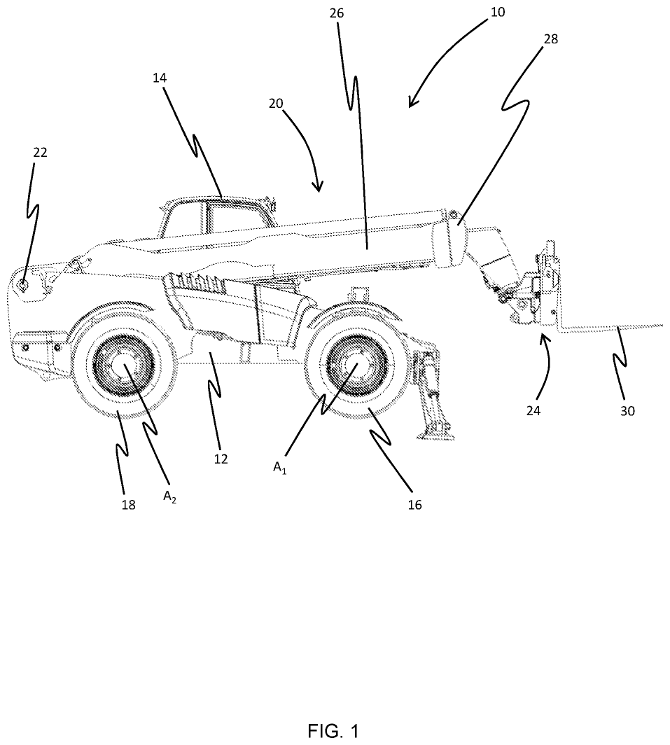

Referring firstly to FIG. 1, an embodiment of the teachings includes a working machine 10. The working machine may be a load handling machine. In this embodiment, the load handling machine 10 is a telescopic handler. In other embodiments the load handling machine 10 may be a rotating telescopic handler, a forklift, a skid-steer loader, a compact track loader, a wheel loader, or a telescopic wheel loader, for example. Such working machines may be denoted as off-highway vehicles. The working machine 10 includes a machine body 12. The machine body 12 may include, for example, an operator's cab 14 from which an operator can operate the machine 10. The working machine 10 has a ground engaging propulsion arrangement. The ground engaging propulsion arrangement or structure supports the body 12. A working arm 20 is pivotally connected to the body 12. The working arm 20 is connected to the body 12 by a mount 22 proximate a first, or proximal, end of the working arm 20.

In some arrangements, the body 12 may include an undercarriage or chassis including the ground engaging propulsion arrangement, and a superstructure including the cab and arm, and the superstructure may be rotatable (e.g. about a substantially vertical axis) relative to the undercarriage/chassis. Put another way, the superstructure may be rotatable relative to the ground engaging propulsion structure.

The ground engaging propulsion structure includes a first, or front, axle A1 and a second, or rear, axle A2, each axle being coupled to a pair of wheels 16, 18. In other embodiments, the ground engaging propulsion structure may include a pair of endless tracks. One or both of the axles A1, A2 may be coupled to a drive arrangement (not shown) configured to drive movement of the ground engaging propulsion structure (i.e. the axles A1, A2). The drive arrangement causes movement of the working machine 10 over a ground surface. The drive arrangement includes a primer mover and a transmission. The prime mover may be an internal combustion engine, an electric motor, or may be a hybrid comprising both an internal combustion engine, an electric motor.

The working arm 20 may be a telescopic arm, having a first section 26 connected to the mount 22 and a second section 28 which is telescopically fitted to the first section 26. In this embodiment, the second section 28 of the working arm 20 is telescopically moveable with respect to the first section 26 such that the working arm 20 can be extended and retracted. Movement of the second section 28 with respect to the first section 26 of the working arm 20 may be achieved by use of an extension actuator (not shown), for example a double acting hydraulic linear actuator, an electric linear actuator, a telescopic extension ram, multiple extension rams, and/or a chain and pulley system. As will be appreciated, the working arm 20 may include a plurality of sections, for example two, three, four or more sections. Each arm section may be telescopically fitted to at least one other section, and an actuator may be provided therebetween.

The working arm 20 can be moved with respect to the machine body 12 and the movement is preferably, at least in part, rotational movement about the mount 22. The rotational movement is about a substantially transverse axis of the machine 10. Rotational movement of the working arm 20 with respect to the machine body 12 is, in an embodiment, achieved by use of at least one lifting actuator (not shown) coupled between the arm 20 and the body 12.

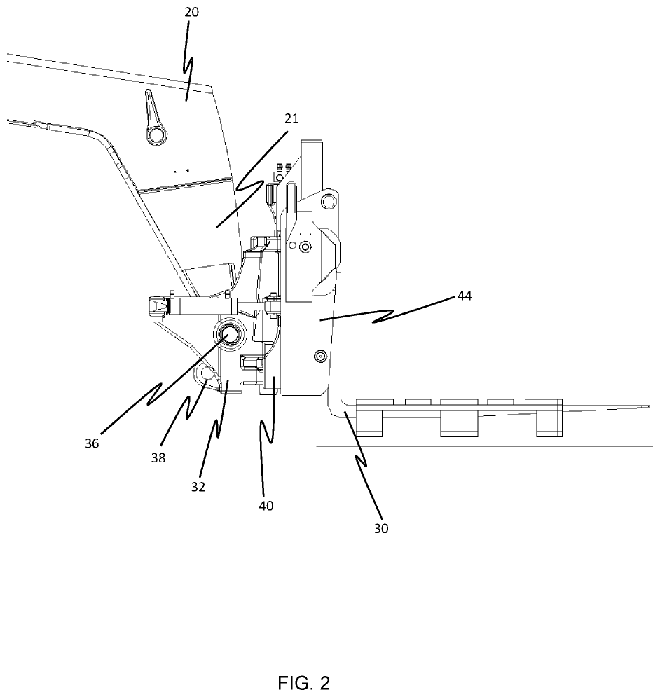

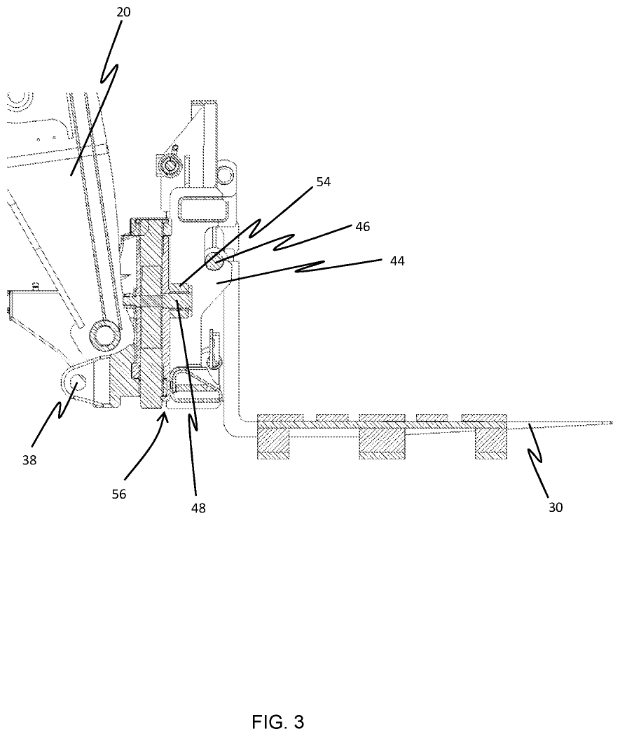

Referring now to FIGS. 2 and 3, a carriage assembly 24 is mounted to a second, or distal, end 21 of the working arm 20. A working implement, e.g. a load handling implement, 30 is mounted to the carriage assembly 24. The working machine 10 is configured to transport loads over uneven ground, i.e. with a load held by the working implement 30, an operator controls the ground engaging propulsion structure to move the machine 10 with the load from one location to another. In the illustrated arrangement, the working implement is a pair of forks 30, e.g. a pair of laterally spaced apart forks. The forks 30 project forwardly from the carriage assembly 24. In alternative arrangements, the working implement may be a bucket, or a basket etc. The carriage assembly 24 enables a working implement 30 to be maneuvered/rotated about three planes (i.e. about first, second and third axes), as is discussed in more detail below.

The carriage assembly 24 includes a first coupling body 32. The first coupling body 32 is integrally formed, e.g. integrally cast, as a unitary component. The first coupling body 32 includes an arm mounting arrangement 34 for pivotally mounting the first coupling body 32 to the working arm 20. The first coupling body 32 is pivotable relative to the working arm 20 about a first axis X. The first axis X is a lateral axis or horizontal axis. Put another way, the first axis X is a substantially transverse axis of the machine 10. The first axis X is substantially parallel to the rotational axis between the working arm 20 and the body 12.

The arm mounting arrangement 34 is provided in the form of a pair of opposing tilt pin holes 34 configured to receive a tilt pin 36 therethrough for mounting the first coupling body 32 to the working arm 20. The tilt pin 36 extends along the first axis X. The first axis X extends in a direction between the first and second tilt pin holes 34. Put another way, the first axis X is defined by an axis extending between the first and second tilt pin holes 34.

The first coupling body 32 includes a tilt actuator mount 38 for mounting a tilt actuator (not shown) that is connected to the working arm 20. The tilt actuator is configured to tilt the first coupling body 32 relative to the working arm 20 about the first axis X.

The carriage assembly 24 includes a second coupling body 40. The second coupling body 40 is integrally formed, e.g. integrally cast, as a unitary component. The second coupling body 40 is pivotally mounted to the first coupling body 32. The second coupling body 40 is pivotable relative to first coupling body 32 about a second axis Z that is substantially perpendicular to the first axis X. The second axis Z is a substantially upright axis. Put another way, the second axis Z is a vertical axis.

The second coupling body 40 includes a swivel mounting arrangement 42 in the form of opposing first and second swivel pin holes 42. The first and second swivel pin holes 42 are configured to receive a swivel pin 80 therethrough for pivotally mounting the second coupling body 40 to the first coupling body 32. The swivel pin 80 extends along the second axis Z. The second axis Z extends in a direction between the first and second swivel pin holes 42. Put another way, the second axis Z is defined by an axis extending between the first and second swivel pin holes 42.

The carriage assembly 24 includes a carriage 44. The carriage 44 has an implement mount 46 for mounting a working implement thereon. In the illustrated embodiment, the implement mount includes a fork mounting shaft 46. The fork mounting shaft 46 is arranged so as to be substantially parallel with the first axis X.

The carriage 44 is pivotally mounted to the second coupling body 40. The carriage 44 is pivotable relative to the second coupling body 40 about a third axis Y. The third axis Y is substantially perpendicular to the first axis X and the second axis Z. The third axis is a substantially fore-aft axis. The third axis Y is substantially parallel to the direction of projection of the forks 30 from the carriage assembly 24.

The carriage 44 is pivotally mounted to the second coupling body 40 via a pivot pin 48. A bearing 54 is arranged around the first end of the pivot pin so as to be interposed between the pivot pin 48 and the carriage 44. The second coupling body 40 includes a pivot pin hole 50 configured to receive the pivot pin 48 therethrough for pivotally mounting the carriage 44 to the second coupling body 40. The bearing 54 is interposed between the pivot pin 48 and the pivot pin hole 50. The pivot pin 48 extends along the third axis Y. Put another way, the pivot pin hole 50 defines the third axis Y.

The pivot pin 48 includes a stop 52 at a first or forward end for abutting against the carriage 44. The pivot pin 48 includes a releasable fastening arrangement at a second or rearward end of the pivot pin 48 for securing the pivot pin 48 to second coupling body 40. The fastening arrangement includes an external threaded portion at the second end of the pivot pin 48 and a threaded fastener.

In order to improve load transfer through the carriage assembly 24, a rear surface of the carriage 44 abuts against a forward face of the second coupling body 40 at a position below the pivot pin 48. The rear surface of the carriage 44 and the forward face of the second coupling body 40 form a load transfer region 56 below the third axis Y. The load transfer region 56 extends laterally across the carriage assembly 24, e.g. an entirety of the carriage assembly. Put another way, the load transfer region 56 extends laterally across the second coupling body 40 and the carriage 40. This has been found to improve load transfer through the carriage assembly 24, by reducing the moment of force exerted on the pivot pin 48.

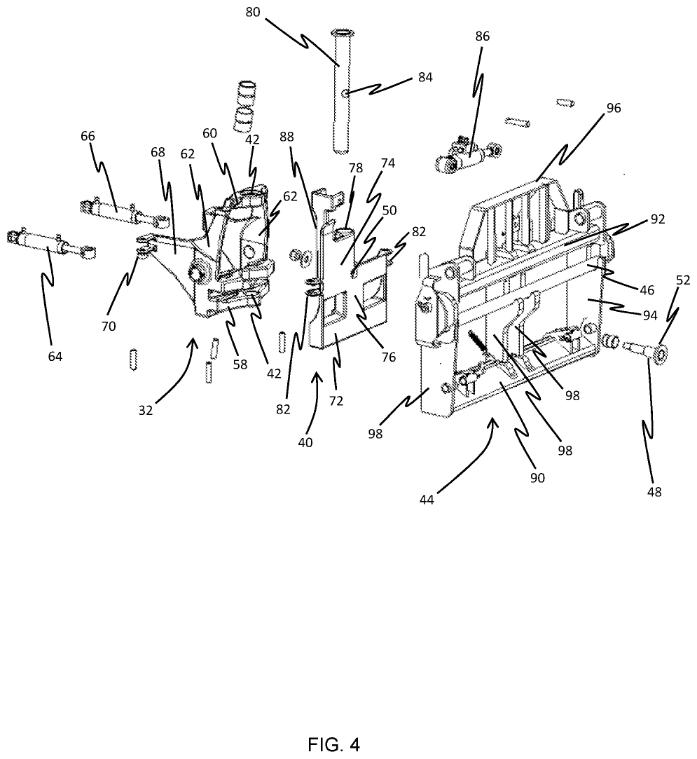

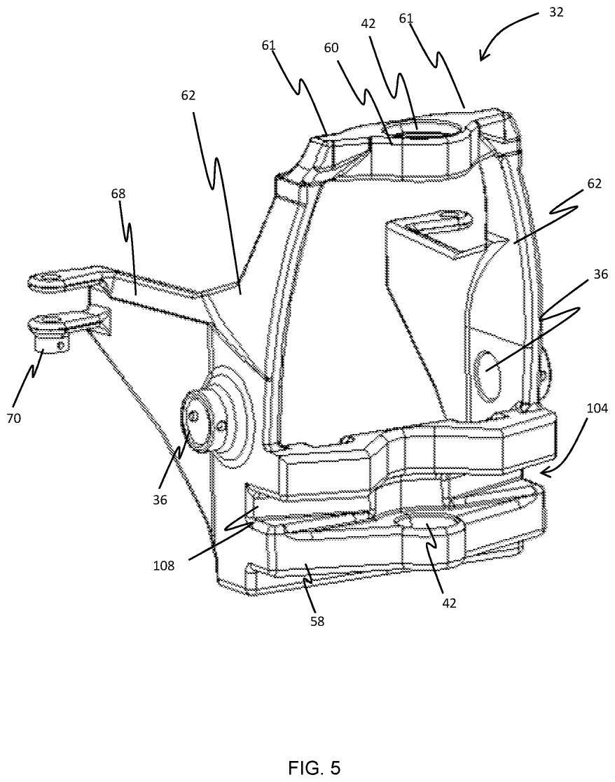

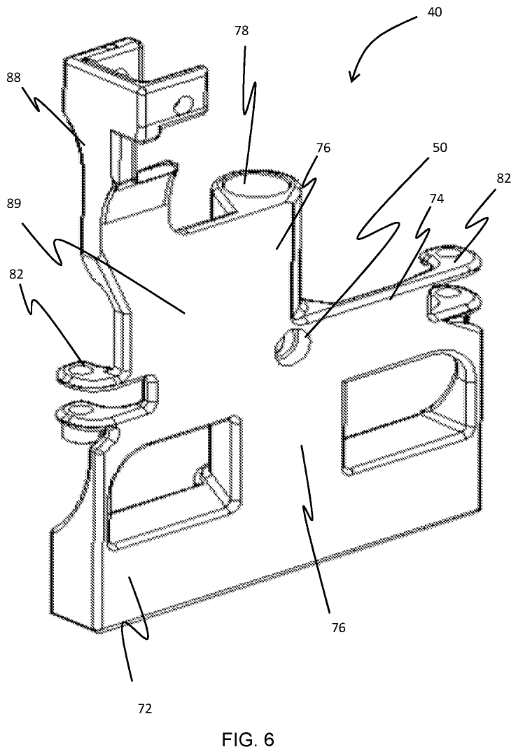

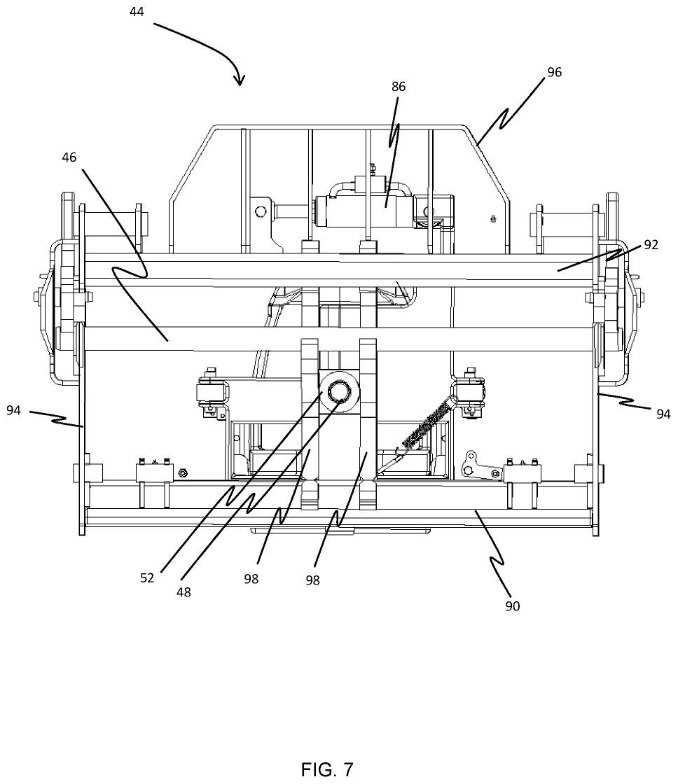

Referring now to FIGS. 4 to 7, the first coupling body 32 includes a lower base member 58, an upper bridge member 60, and first and second side walls 62 extending therebetween. The arm mounting arrangement is provided in the form of opposing first and second tilt pin holes 34 in the first and second side walls 62. The tilt actuator mount 38 is provided on the base member 58. The swivel mounting arrangement is provided in the form of first and second swivel pin holes 42 in the base member 58 and bridge member 60.

The spacing between the first and second swivel pin holes 42 is greater, for example 1.25 or 1.5 times greater, than the spacing between the first and second tilt pin holes 34. Put another way, the spacing between the base member 58 and bridge member 60 is greater, for example 1.25 or 1.5 times greater, than the spacing between the first and second side walls 62. Providing a first coupling body that is taller than it is wide has been found to reduce the stress on the components of the first coupling body 32, i.e. on the carriage assembly 24.

The carriage assembly 24 includes a first swivel actuator 64 pivotally connected between the first coupling body 32 and the second coupling body 40 to pivot the second coupling body 40 about the second axis Z. The first swivel actuator 64 is connected between a first side wall 62 of the first coupling body 32 and a first lateral side of the second coupling body 40.

The carriage assembly 24 includes a second swivel actuator 66 pivotally connected between the first coupling body 32 and the second coupling body 40 to pivot the second coupling body 40 about the second axis Z. The second swivel actuator 66 is connected between the second side wall 62 of the first coupling body 32 and a second lateral side of the second coupling body 40. It will be appreciated that in some arrangements, only a single swivel actuator may be provided.

The first swivel actuator 64 and the second swivel actuator 66 connect to the first coupling body 32 at a position rearward (i.e. in a direction away from the second coupling body 40 and the carriage 44) of the first axis X. Put another way, the first swivel actuator 64 and the second swivel actuator 66 connect to the first coupling body 32 at a position on an opposing side of the first axis X relating to the second coupling body 40 and the carriage 44. The first swivel actuator 64 and the second swivel actuator 66 connect to the first coupling body 32 at first swivel actuator mounts 70.

In the illustrated arrangement, the first and second side walls 62 each include a wing portion 68 extending rearwardly relative to the first axis X. Put another way, the first and second side walls 62 each include a wing portion 68 extending in a direction away from the second coupling body 40 and the carriage 44. The first swivel actuator 64 and the second swivel actuator 66 connect to the respective wing portion 68. The first swivel actuator mounts 70 are provided on the wing portions 68 of the first coupling body 32. The first swivel actuator 64 and the second swivel actuator 66 connect to a distal end of the respective wing portion 68. This provision of rearwardly extending wings 68 (i.e. side wall portions extending in a direction away from the carriage 44 towards the body 12 of the machine 10) works to bring the center of gravity of the carriage assembly 24 closer to the distal end of the working arm 20.

As discussed above, the bridge member 60 includes a swivel pin hole 42 therethrough. A surface, e.g. a rear surface, of the bridge member 60 is arranged to face the working arm 20 (i.e. the surface is on an opposing side of the bridge member 60 to the second coupling body 40). The surface of the bridge member 60 includes first and second recesses 61 in side or lateral regions of the bridge member 60. The first and second lateral recesses 61 are configured and arranged to receive opposing side walls of the arm 20 therein. This arrangement helps to increase the maximum pivoting of the first coupling body 32 relative to the arm 20 about the first axis X. The first and second lateral recesses 61 may be substantially curved. This helps to reduce the stress within the first coupling body 32.

The second coupling body 40 includes a lower cross member 72, an upper cross member 74, and swivel shaft member 76 extending therebetween. The swivel shaft member 76 is arranged to be substantially central on the second coupling body 40. Put another way, the swivel shaft member 76 is substantially central between the lateral sides of the second coupling body 40.

The swivel shaft member 76 includes an elongate bore 78 configured to receive a swivel pin 80 therethrough. The swivel pin 80 extends through the swivel pin holes 42 in the first coupling body 32 and through the bore 78 to pivotally mount the second coupling body 40 to the first coupling body 32. The bore 78 extends along the second axis Z. Put another way, the elongate bore 78 defines the second axis Z.

The second coupling body 40 includes a second swivel actuator mount 82 on first and second lateral sides of the upper cross member 74. The pivot pin hole 50 is positioned between, e.g. interposed between, the opposing second swivel actuator mounts 82 provided on first and second lateral sides of the second coupling body 40. The pivot pin hole 50 is aligned vertically with the opposing second swivel actuator mounts 82. In the illustrated arrangement, the pivot pin hole 50 is positioned at a point of intersection between the upper cross member 74 and the swivel shaft member 76.

The pivot pin hole 50 and the elongate bore 78 are substantially perpendicular and intersect. In the illustrated arrangement, the swivel pin 80 includes an aperture 84 configured to receive the pivot pin 48 therethrough. In some arrangements, the pivot pin 48 may be provided with an external threaded portion and the aperture 84 of the swivel pin 80 may be provided with an internal threaded portion configured to engage the external threaded portion of the pivot pin 48.

The pivot pin 48 includes a stepped region such that a reduced diameter portion of the pivot pin 48 extends through the aperture 84. This reduces the diameter of the aperture 84 required, and so reduces required diameter of the swivel pin 80. The stepped region may form a stop configured to abut against a perimeter of the pivot pin hole 50.

The carriage assembly 24 includes a pivot actuator 86 pivotally connected between the second coupling body 40 and the carriage 44. The pivot actuator 86 pivots the carriage 44 relative to the second coupling body 40 about the third axis Y (i.e. about the pivot pin 48).

The pivot actuator 86 is positioned above the third axis Y. The pivot actuator 86 is positioned above first and second coupling bodies 32, 40. The second coupling body 40 includes a bracket arm 88 extending from the upper cross member 74 in a direction at least partially away from the lower cross member 72. Put another way, the second coupling body 40 includes a bracket arm 88 extending upwardly from the upper cross member 74. The bracket arm 88 extends from the upper cross member 74 and the swivel shaft member 76. The bracket arm 88 includes a support plate 89 extending between the upper cross member 74 and the swivel shaft member 76. The pivot actuator 86 is pivotally mounted proximate a distal end of the bracket arm 88. The bracket arm 88 acts as a mechanical stop to limit the maximum pivoting angle of the carriage 44 relative to the second coupling body 40.

The carriage 44 is formed from a lower lateral member 90, an upper lateral member 92, and two side members 94 extending therebetween. As is illustrated in FIG. 3, the lower lateral member 90 of the carriage 44 is substantially flush with, e.g. abuts against, the lower cross member 72 of the second coupling body 40. In this way, the lower lateral member 90 of the carriage 44 and the lower cross member 72 of the second coupling body 40 form the load transfer region 56.

The pivot actuator 86 is positioned above the upper lateral member 92. The carriage 44 includes a guard frame 96 extending upwardly from then upper lateral member 92 (i.e. in a direction away from the lower lateral member 90). The guard frame 96 is positioned forwardly of the pivot actuator 86 to protect the pivot actuator 86 from collisions during operation of the working machine 10.

The carriage 44 includes a pair of spaced apart support members or support brackets 98. The support members 98 extend between the upper and lower lateral members 90, 92 and are secured thereto. A pivot plate (not shown) is mounted to the first and second support members 98, and the pivot plate includes a pivot hole (not shown) to receive the pivot pin therethrough. The implement mount 46 is provided in the form of a fork mounting shaft extending between the two side members 94. The support members 98 support the fork mounting.

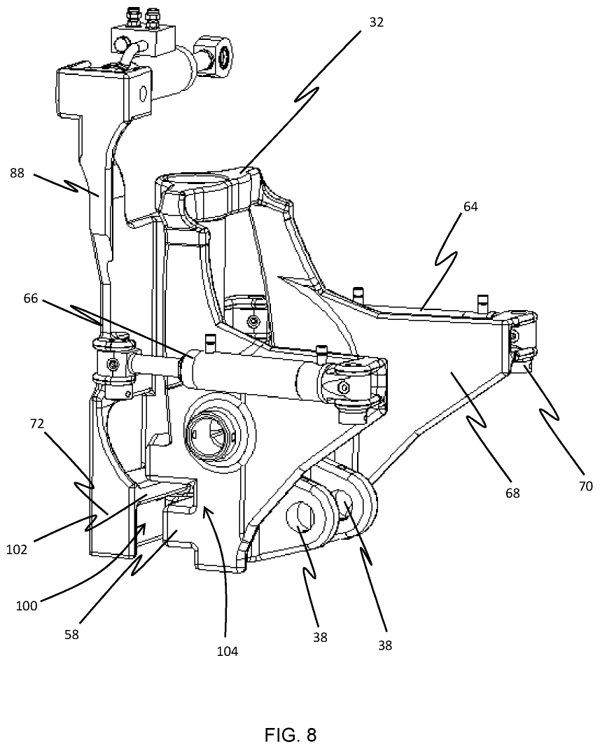

Referring to FIG. 8, the second coupling body 40 is provided with a recessed or cut-out portion 100. The recessed or cut-out portion 100 is provided on a surface of the second coupling body 40 that faces the first coupling body 32 and is configured to receive a portion of the first coupling body 32 therein. The recessed or cut-out portion 100 is provided on the lower cross member 72 of the second coupling body 40. The recessed or cut-out portion 100 receives a portion of the base member 58 therein.

The elongate bore 78 for the swivel pin 80 extends into the recess 100. Put another way, the bore 78 terminates at an upper wall 102 of the recess. The second coupling body 40 is arranged such that the upper and lower extents of the bore 78 align with the opposing swivel pin holes 42 in the first coupling body 32. Put another way, the second coupling body 40 is arranged such that a lower extent of the bore 78 aligns with the swivel pin hole 42 in the base member 58.

A portion of the second coupling body 40 is seated on the first coupling body 32. The upper wall 102 of the recess 100 is seated on the base member 58. The first coupling body 32 defines a lateral groove 104 extending thereacross. The lateral groove 104 is provided on the base member 58. The upper wall 102 of the recess 100 is received in the lateral groove 104. The upper wall 102 of the recess 100 is received in the lateral groove 104 so as to be seated on the first coupling body 32. The upper wall 102 of the recess 100 is seated on a lower wall of the lateral groove 104.

The second coupling body 40 and the first coupling body 32 interengage to form a stop to limit a pivoting angle of the second coupling body 40 relative to the first coupling body 32. The upper wall 102 of the recess 100 and the lateral groove 104 interengage to form a stop to limit a pivoting angle of the second coupling body 40 relative to the first coupling body 32. The groove 104 defines a rear wall 108 that abuts against the upper wall 102 of the recess 100 to limit the pivoting angle of the second coupling body 40 relative to the first coupling body 32.

Although the teachings have been described above with reference to one or more preferred embodiments, it will be appreciated that various changes or modifications may be made without departing from the scope as defined in the appended claims.

1. A carriage assembly for mounting to a working arm of a working machine, the carriage assembly comprising:
a first coupling body comprising an arm mounting arrangement for pivotally mounting the first coupling body to an arm of a working machine so as to be pivotable relative to the arm about a first axis;
a second coupling body pivotally mounted to the first coupling body so as to be pivotable relative to first coupling body about a second axis that is substantially perpendicular to the first axis; and
a carriage comprising an implement mount for mounting a working implement thereon,
wherein the carriage is pivotally mounted to the second coupling body so as to be pivotable relative to the second coupling body about a third axis that is substantially perpendicular to the first axis and the second axis.

2. The carriage assembly according to claim 1, wherein the first axis is a lateral axis, and/or wherein the second axis is a substantially upright axis, and/or wherein the third axis is a fore-aft axis.

3. The carriage assembly according to claim 1, wherein the first coupling body comprises a base member, a bridge member, and first and second side walls extending therebetween, further wherein the arm mounting arrangement comprises opposing first and second tilt pin holes in the first and second side walls, respectively, configured to receive a tilt pin therethrough for mounting the first coupling body to a working arm of a working machine.

4. The carriage assembly according to claim 3, comprising a first swivel actuator pivotally connected between the first coupling body and the second coupling body to pivot the second coupling body about the second axis, and optionally wherein the first swivel actuator is connected between the first side wall of the first coupling body and a first lateral side of the second coupling body.

5. The carriage assembly according to claim 4, comprising a second swivel actuator pivotally connected between the first coupling body and the second coupling body to pivot the second coupling body about the second axis, and optionally wherein the second swivel actuator is connected between the second side wall of the first coupling body and a second lateral side of the second coupling body, optionally wherein the first and second side walls each comprise a wing portion extending rearwardly from the first axis in a direction away from the second coupling body.

6. The carriage assembly according to claim 5, wherein the first swivel actuator and/or second swivel actuator connect to the first coupling body rearward of the first axis, optionally wherein the first swivel actuator and/or second swivel actuator connect to a respective wing portion, e.g. a distal end of the respective wing portion.

7. The carriage assembly according to claim 3, wherein the first coupling body comprises a swivel mounting arrangement in the form of opposing first and second swivel pin holes in the base member and bridge member, respectively, configured to receive a swivel pin therethrough for pivotally mounting the second coupling body to the first coupling body, optionally wherein the first and second swivel pin holes are spaced apart by a distance greater, e.g. 1.25 or 1.5 times greater, than a spacing between the first and second tilt pin holes.

8. The carriage assembly according to claim 1, wherein the second coupling body comprises a lower cross member, an upper cross member, and a substantially central swivel shaft member extending therebetween, and wherein the swivel shaft member comprises an elongate bore configured to receive a swivel pin therethrough for pivotally mounting the second coupling body to the first coupling body, optionally wherein the second coupling body comprises a first and/or second swivel actuator mounts on first and/or second lateral sides of the upper cross member.

9. The carriage assembly according to claim 1, wherein the second coupling body comprises a pivot pin hole configured to receive a pivot pin therethrough for pivotally mounting the carriage to the second coupling body, optionally wherein the pivot pin hole defines the third axis.

10. The carriage assembly according to claim 9, wherein the pivot pin hole is positioned between, e.g. interposed between, first and second swivel actuator mounts provided on first and second lateral sides of the second coupling body, optionally wherein the pivot pin hole and the elongate bore are substantially perpendicular and intersect, optionally wherein the swivel pin comprises an aperture configured to receive the pivot pin therethrough.

11. The carriage assembly according to claim 1, wherein the second coupling body comprises a recess on a surface facing the first coupling body, and wherein a portion of the first coupling body extends into the recess, optionally wherein the recess is formed on the lower cross member, optionally wherein the bore terminates at an upper wall of the recess and the first coupling body extends into the recess such that a swivel pin hole of the first coupling body aligns with the bore.

12. The carriage assembly according to claim 11, wherein the recess defines an upper wall that is received in a corresponding lateral groove on the first coupling body, optionally wherein the upper wall of the recess is seated on a part of the first coupling body, optionally wherein the upper wall of the recess is seated on a lower wall of the lateral groove.

13. The carriage assembly according to claim 11, wherein the recess and the first coupling body interengage to form a stop to limit a pivoting angle of the second coupling body relative to the first coupling body, optionally wherein the upper wall and lateral groove interengage to form a stop to limit the pivoting angle of the second coupling body relative to the first coupling body.

14. The carriage assembly according to claim 1, comprising a pivot actuator pivotally connected between the second coupling body and the carriage to pivot the carriage relative to the second coupling body about the third axis.

15. The carriage assembly according to claim 14, wherein the pivot actuator is positioned above the third axis, and optionally wherein the second coupling body comprises a bracket arm extending from the upper cross member in a direction at least partially away from the lower cross member, and wherein the pivot actuator is pivotally mounted proximate a distal end of the bracket arm, optionally wherein the bracket arm acts as a mechanical stop to limit the maximum pivoting angle of the carriage relative to the second coupling.

16. The carriage assembly according to claim 15, wherein the bracket arm acts as a mechanical stop to limit the maximum pivoting angle of the carriage relative to the second coupling body.

17. The carriage assembly according to claim 1, wherein the carriage comprises a lower member, an upper member, and two side members extending therebetween, and wherein the carriage comprises a pair of spaced apart support members and a pivot plate including a pivot hole mounted to the pair of support members.

18. The carriage assembly according to claim 17, wherein the implement mount comprises a fork mounting shaft extending between the two side members, optionally wherein the fork mounting shaft is mounted to the support members, optionally wherein the carriage lower cross member is substantially flush with, e.g. abuts against, the second coupling body, optionally wherein the carriage lower cross member abuts against the lower cross member of the second coupling body.

19. The carriage assembly according to claim 1, wherein the first coupling body is integrally formed, e.g. integrally cast, as a unitary component and/or wherein the second coupling body is integrally formed, e.g. integrally cast, as a unitary component.

20. A working machine comprising:
a body;
a ground engaging propulsion arrangement supporting the body;
a working arm pivotally connected to the body; and
a carriage assembly according to claim 1 mounted to a distal end of the working arm.
